(19) United States
(12) Patent Application Publication
(10) Pub. No.: US 2014/0063043 A1
(43) Pub. Date: Mar. 6, 2014

(54) SYSTEM, METHOD, AND COMPUTER PROGRAM PRODUCT FOR TRANSMITTING OPACITY DATA FOR A PLURALITY OF PIXEL VALUES

(71) Applicants: Jacques Francois Mahe, Los Altos, CA (US); Peter Pipkorn, Partille (SE)

(72) Inventors: Jacques Francois Mahe, Los Altos, CA (US); Peter Pipkorn, Partille (SE)

(73) Assignee: NVIDIA CORPORATION, Santa Clara, CA (US)

(21) Appl. No.: 13/605,882

(22) Filed: Sep. 6, 2012

(51) Int. Cl. G09G 5/02

(52) U.S. Cl. 345/592

(57) ABSTRACT

A system, method, and computer program product are provided for transmitting opacity data for a plurality of pixel values. In use, opacity data is identified for a plurality of pixel values in a first format. Additionally, the opacity data for the plurality of pixel values is stored in a second format. Further, the opacity data for the plurality of pixel values is transmitted, utilizing the second format.

### FIELD OF THE INVENTION

The present invention relates to graphics display, and more particularly to converting graphics data.

### BACKGROUND

Graphics data is commonly used to provide graphics information to displays. For example, a display may produce a graphical image based on graphics data sent to the display. However, current techniques for transmitting graphics data have been associated with various limitations.

For example, many current data transmission mediums limit graphics data transfer to color data. As a result, additional graphics data such as opacity data may not be able to be currently transferred using these transmission mediums. There is thus a need for addressing these and/or other issues associated with the prior art.

### SUMMARY

A system, method, and computer program product are provided for transmitting opacity data for a plurality of pixel values. In use, opacity data is identified for a plurality of pixel values in a first format. Additionally, the opacity data for the plurality of pixel values is stored in a second format. Further, the opacity data for the plurality of pixel values is transmitted, utilizing the second format.

### BRIEF DESCRIPTION OF THE DRAWINGS

FIG. 1 shows a method for transmitting opacity data for a plurality of pixel values, in accordance with one embodiment.

FIG. 2 shows a method for carrying an alpha channel across an RGB display, in accordance with another embodiment.

FIG. 3 shows an exemplary source frame buffer, in accordance with another embodiment.

FIG. 4 illustrates an exemplary system in which the various architecture and/or functionality of the various previous embodiments may be implemented.

### DETAILED DESCRIPTION

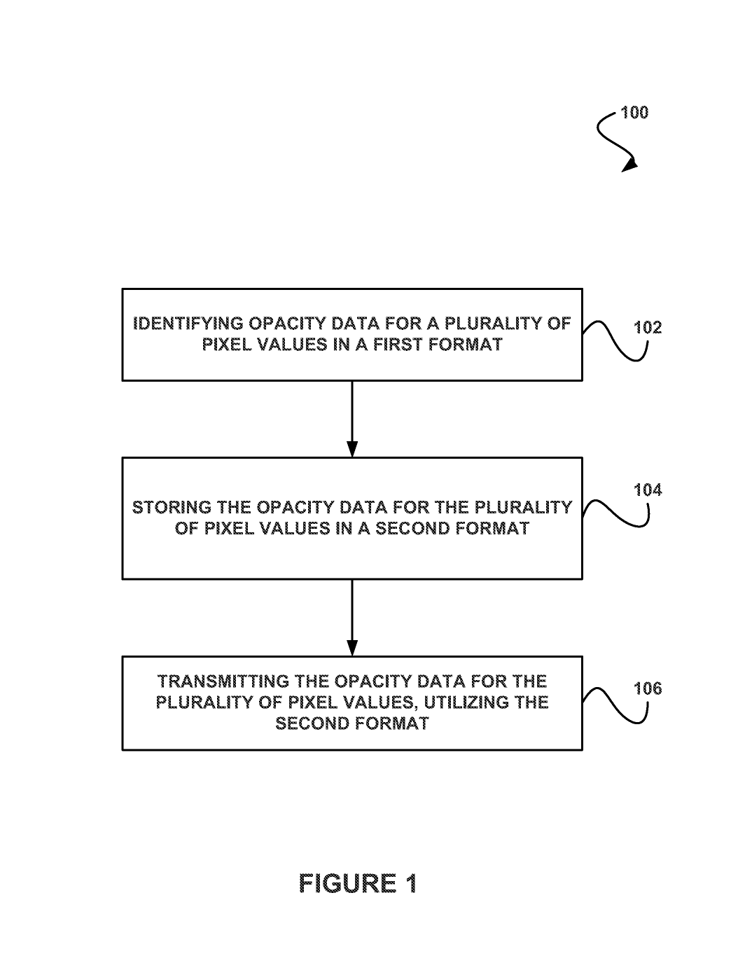

FIG. 1 shows a method 100 for transmitting opacity data for a plurality of pixel values, in accordance with one embodiment. As shown in operation 102, opacity data is identified for a plurality of pixel values in a first format. In one embodiment, color data and opacity data may be defined for each pixel of the plurality of pixels in the first format. For example, each pixel value of the plurality of pixel values may have associated color data and opacity data.

Additionally, in one embodiment, the plurality of pixel values may be associated with one or more images. For example, the plurality of pixel values may correspond to a plurality of pixels that are included within a scene to be shown on a display. In another embodiment, the color data and opacity data for each pixel value may respectively indicate a color and opacity of that pixel when the pixel is displayed. In yet another embodiment, the color data for each pixel value may include red, green, and blue (RGB) data (e.g., data indicating a color within the RGB color model, etc.). For example, the color data for each pixel value may include a red value, a green value, and a blue value associated with that pixel.

Further, in one embodiment, the opacity data for each pixel value may include an alpha value for the pixel. For example, the opacity data for each pixel value may be indicative of the opacity and/or the transparency of the pixel. In another embodiment, the opacity data for each pixel value may be used when performing alpha compositing including the pixel, alpha blending including the pixel, or other graphics transparency operations involving the opacity of the pixel.

Further still, in one embodiment, the first format of the plurality of pixel values may include a red green blue alpha (RGBA) format. For example, each of the plurality of pixels may have an associated RGBA pixel value indicating the color and opacity of that pixel. In another embodiment, the first format of the plurality of pixel values may have an associated size. For example, the RGBA value for each pixel may be 32 bits in size. In yet another embodiment, the plurality of pixel values may be stored in a data structure (e.g., a frame buffer, etc.) in a memory. For example, the plurality of pixel values may be stored as a graphic surface within a frame buffer.

Also, as shown in operation 104, the opacity data for the plurality of pixel values is stored in a second format. In one embodiment, storing the opacity data for the plurality of pixel values in the second format may include gathering the opacity data from the plurality of pixel values. For example, a pass shader of a graphics processing unit (GPU) may extract alpha values from each of the plurality of pixel values. In another embodiment, storing the opacity data for the plurality of pixel values in the second format may include creating one or more opacity storage values in the second format. For example, the opacity storage values may include new pixel values that are created in the second format and that may be used to exclusively save opacity values for the plurality of pixel values.

In addition, in one embodiment, storing the opacity data for the plurality of pixel values in the second format may include storing the extracted opacity data from the plurality of pixel values in the one or more opacity storage values. For example, the one or more opacity storage values may indicate the opacity data for the plurality of pixel values. In another embodiment, the second format of the one or more opacity storage values may include a red green blue (RGB) format.

For example, the red, green, and blue values within the RGB formatted opacity storage value may each refer to an opacity value associated with a pixel value. In yet another embodiment, the second format of the one or more opacity storage values may have an associated size. For example, the RGB value for each opacity storage value may be 24 bits in size.

Further, in one embodiment, a single opacity storage value may store opacity data for a plurality of pixel values. For example, each single opacity storage value may store the opacity data of three pixel values. In another embodiment, both the plurality of pixel values and the opacity storage values may be stored within a memory. For example, both the plurality of pixel values and the opacity storage values may be stored within a frame buffer.

Further still, in one embodiment, the one or more opacity storage values may be stored in association with the plurality of pixel values within a data structure in memory. In another embodiment, the data structure in the memory may be adjusted to allow the storage of both the opacity storage values and the plurality of pixel values within the data structure. For example, a graphic surface stored within a frame buffer may be designed to store the plurality of pixel values as well as the positioning of the pixels with respect to each other, and such graphic surface may be increased in size to accommodate the storage of the opacity storage values in addition to the storage of the plurality of pixel values.

In another example, the graphic surface may be increased in size by increasing a pitch (e.g., a distance between two lines, a line width, etc.) within the graphic surface. In yet another example, the one or more opacity storage values may be stored to the left or right side of the plurality of pixel values within the graphic surface. In yet another example, each of the one or more opacity storage values may be stored in a predetermined position within the graphic surface, such that the opacity data within the opacity storage values may be matched to its respective pixel value.

Also, in one embodiment, a pass shader of a graphics processing unit (GPU) may store the extracted opacity data from the plurality of pixel values in the one or more opacity storage values. In another embodiment, the pass shader may perform the extraction of the opacity data and the storage of the extracted opacity data in a single pass.

Additionally, as shown in operation 106, the opacity data for the plurality of pixel values is transmitted, utilizing the second format. In one embodiment, the opacity data for the plurality of pixel values may be transmitted to a microcontroller unit (MCU) controlling a display (e.g., a console, a television, etc.). In another embodiment, transmitting the opacity data for the plurality of pixel values may include transmitting the opacity storage values with the plurality of pixel values. For example, the entire graphic surface stored within the frame buffer (including the one or more opacity storage values may be stored in association with the plurality of pixel values) may be transmitted to the MCU.

Further, in one embodiment, the opacity data for the plurality of pixel values may be transmitted utilizing an interface connection. For example, the opacity data for the plurality of pixel values may be transmitted utilizing a low voltage differential link (LVDS), a digital RGB link, a flat panel display link (FPD-Link), an automotive pixel link, (APIX2 link), etc. In another embodiment, the interface connection may follow a communications standard. For example, the opacity data for the plurality of pixel values may be transmitted in accordance with a low voltage differential signaling (LVDS) standard. In yet another embodiment, the interface connection may include a 24-bit connection.

Further still, in one embodiment, the interface connection utilized for transmission may support the second format, but may not fully support the first format. For example, both the pixel values in the first format and the opacity storage values in the second format may be transmitted utilizing the interface connection, but the interface connection may discard a portion of the pixel values in the first format (e.g., the opacity data for the pixel values in the first format) during transmission, such that the received pixel values may be incomplete. In another example, the entirety of the opacity storage values in the second format may be correctly transmitted utilizing the interface connection.

Also, in one embodiment, the recipient of the opacity data for the plurality of pixel values may use the opacity data for the plurality of pixel values to recreate the plurality of incomplete pixel values in the first format. For example, a shader at a receiving MCU may receive the transmitted graphic surface stored within the frame buffer, where the transmitted graphic surface may include the one or more opacity storage values in addition to the plurality of pixel values.

Additionally, as a result of the transmission, the opacity data for each of the received pixel values may have been discarded. Further, the received opacity storage values may be used by the shader at the receiving MCU to recreate the discarded opacity data for each of the received pixel values. In this way, a plurality of pixel values in a first format may be transmitted over an interface connection that does not support the first format.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

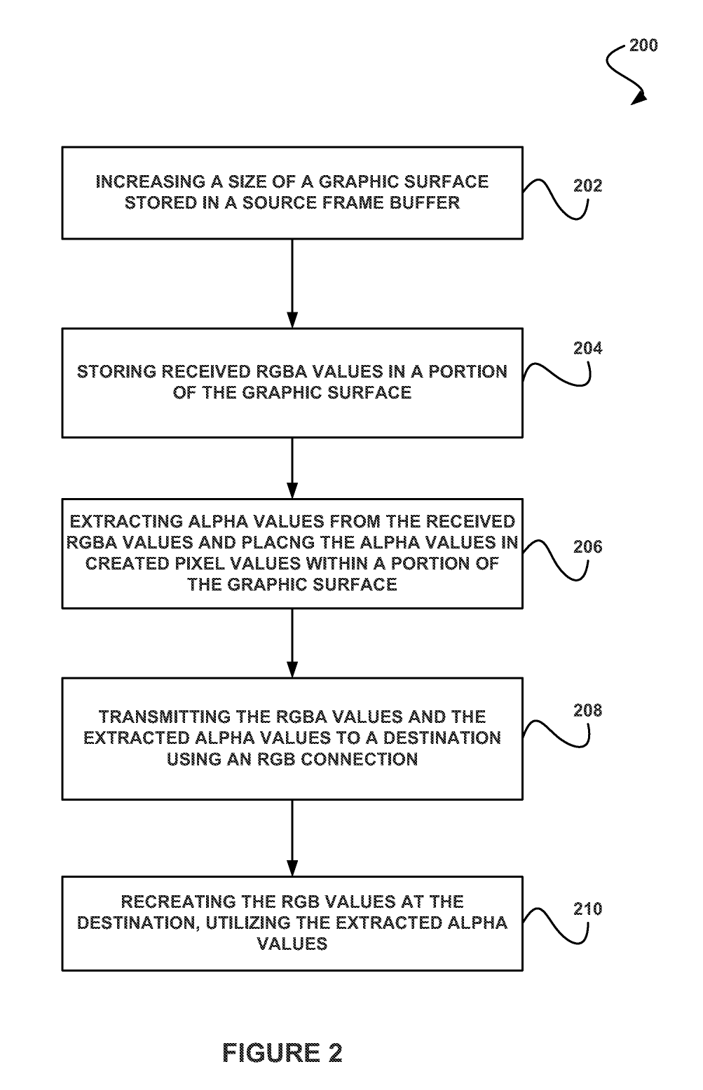

FIG. 2 shows a method 200 for carrying an alpha channel across an RGB display, in accordance with another embodiment. As an option, the method 200 may be carried out in the context of the functionality of FIG. 1. Of course, however, the method 200 may be implemented in any desired environment. It should also be noted that the aforementioned definitions may apply during the present description.

As shown in operation 202, a graphic surface stored in a source frame buffer is increased in size. In one embodiment, the graphic surface may include a final graphic surface to be sent to a microcontroller unit (MCU) at a destination for display at the destination (e.g., using a display device such as a television, monitor, etc.). In another embodiment, the graphic surface may include an overlay layer.

Additionally, in one embodiment, increasing the size of the graphic surface stored in the frame buffer may include increasing a pitch of the graphic surface (e.g., a distance between two lines of the graphic surface, etc.). For example, each line width of the graphic surface may be expanded. Table 1 illustrates an exemplary line width expansion. Of course, it should be noted that the line width expansion shown in Table 1 is set forth for illustrative purposes only, and thus should not be construed as limiting in any manner.

TABLE 1
new line width = original line width + alignment + (original line width +
2)/3

Further, in one embodiment, the current application may work on a surface having dimensions (original width*original height) with a pitch having dimensions of (original width+alignment (original width+2)/3). In another embodiment, the alignment may have any value from zero to the minimum alignment requirement that may be based on display surface and controller (e.g., display and capture, etc.) requirements.

For example, if the display surface is associated with linear graphic memory, the alignment may have a value of zero. In another example, if the display surface is associated with tiled memory, then the alignment may have a value corresponding to a size of a tile. In this way, the size of the graphic surface may be increased to (n+n/3+alignment).

Further still, as shown in operation 204, received RGBA values are stored in a portion of the graphic surface that has been increased in size. In one embodiment, the received RGBA values may correspond to an image that is to be displayed at the destination. In another embodiment, the received RGBA values may be stored on a left side of the graphic surface within the source frame buffer, a right side of the graphic surface within the source frame buffer, etc.

Also, as shown in operation 206, alpha values are extracted from the received RGBA values and are placed in created pixel values within a portion of the graphic surface. In one embodiment, a pass shader may gather alpha values from three consecutive RGBA values. For example, the pass shader may gather alpha values corresponding to [A(n)R(n)G(n)B(n), A(n+1)R(n+1)G(n+1)B(n+1), A(n+2)R(n+2)G(n+2)B(n+2)] where n % 3=0. In another embodiment, the pass shader may create a pixel of value [xA(n)A(n+1)A(n+2)] where x may be anything at position “Original Width+alignment+n/3” in the graphic surface.

In yet another embodiment, the alignment may be surface type dependent, and the RGB plane may not be pitch linear. In this way, three alpha values of the RGBA original surface may be packed into one new created RGB pixel value. In another embodiment, the created pixel values may be placed onto a left side or a right side of the graphic surface (e.g., to the left of the stored RGBA values, to the right of the stored RGBA values, etc.). In still another embodiment, the extracting of the alpha values and the placing of the extracted alpha values in created pixel values within the portion of the graphic surface may all be performed in a single pass using a three-dimensional (3D) engine (e.g., a pass shader, etc.).

In addition, as shown in operation 208, the RGBA values and extracted alpha values are transmitted to a destination using an RGB connection. In one embodiment, the RGBA values and extracted alpha values may be sent from the source frame buffer at a first MCU to a destination frame buffer at a second MCU. In another embodiment, the RGBA values and extracted alpha values may be used to display an image corresponding to the RGBA values and extracted alpha values.

Further, in one embodiment, during the transmission to the destination, the RGB connection may discard the alpha value within the RGBA values. For example, the RGBA values may be 32 bits in size and the RGB connection may be a 24 bit connection and may therefore discard the alpha value within the 32 bit RGBA value. In another embodiment, during the transmission to the destination, the extracted alpha values packed into newly created RGB pixel values may be successfully sent to the destination. For example, the extracted alpha values packed into newly created RGB pixel values may be 24 bits in size and the RGB connection may be a 24 bit connection and may therefore transmit the entirety of the extracted alpha values to the destination.

Further still, as shown in operation 210, the RGBA values are recreated at the destination, utilizing the extracted alpha values. For example, a pass shader may extract the alpha values that were packed into the newly created RGB pixel values and may use the extracted alpha values to recreate the alpha values of the RGBA values. In another embodiment, the extracting and recreating may be performed by the pass shader in a single pass. In this way, 24 bit display technology and display links may be used to carry an alpha channel as well as RGB data from one MCU to another MCU while minimizing additional memory requirements.

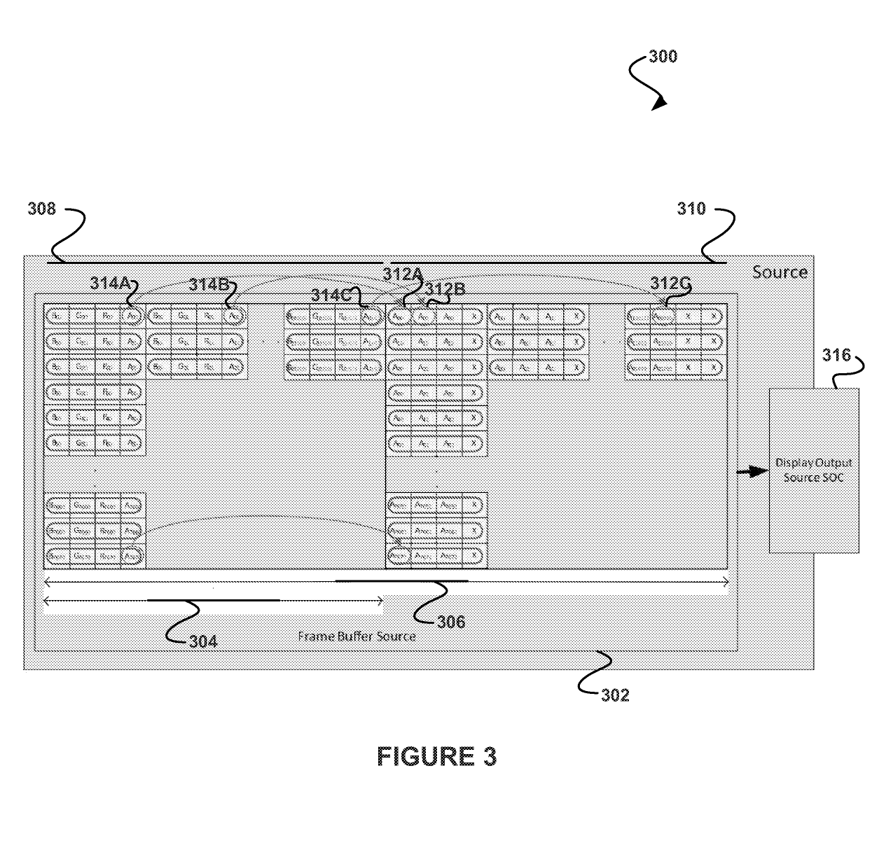

FIG. 3 shows an exemplary source frame buffer 300, in accordance with another embodiment. As an option, the exemplary source frame buffer 300 may be carried out in the context of the functionality of FIGS. 1-2. Of course, however, the exemplary source frame buffer 300 may be implemented in any desired environment. It should also be noted that the aforementioned definitions may apply during the present description.

As shown, the exemplary source frame buffer 300 includes a graphic surface 302 that is expanded from a first width 304 to a second width 306 to accommodate extracted alpha value pixels 310 in addition to RGBA values 308 for the an RGBA surface to be displayed. Additionally, each alpha value 312A-C within the extracted alpha value pixels 310 corresponds to an alpha value 314A-C within the RGBA values 308. In one embodiment, both the extracted alpha value pixels 310 and the RGBA values 308 may be sent to a display output system on a chip (SoC) 316 using a predetermined communication link.

Additionally, in one embodiment, during the transmission of the extracted alpha value pixels 310 and the RGBA values 308 using a predetermined communication link, the communications link may discard the alpha values 314A-C within the RGBA values 308 to create altered RGBA values. In another embodiment, when the extracted alpha value pixels 310 and the altered RGBA values are received at the display output SoC 316, the extracted alpha value pixels 310 may be used to restore the alpha values 314A-C within the RGBA values 308 that were discarded during transfer. As a result, complete RGBA values 308 including alpha values 314A-C may be available at the display output SoC 316 for display.

In this way, only (s+s/3) pixel accesses may be added per frame on both the frame buffer destination (e.g., sink, etc.) and the frame buffer source, where (s) is the target image size. Additionally, (s/3) additional bytes may be added to memory, which may be allocated by a primary buffer for alpha values. Further, display link speed may be increased by one-third of original bandwidth. Further still, display overlays may be used (e.g., to allow a video plane, etc.). More specifically, existing system on a chip (SoC) display hardware that uses alpha values may be utilized, since original pixel values may be unchanged and may be understood by the display hardware. Also, display gamma tables may also be used, which may reduce memory bandwidth.

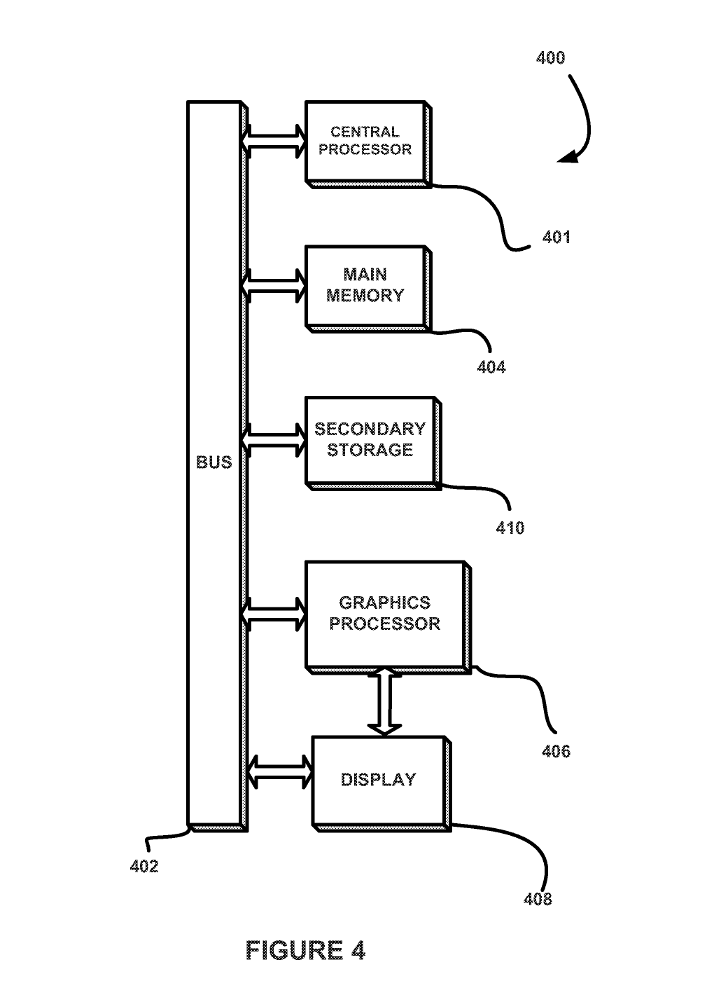

FIG. 4 illustrates an exemplary system 400 in which the various architecture and/or functionality of the various previous embodiments may be implemented. As shown, a system 400 is provided including at least one host processor 401 which is connected to a communication bus 402. The system 400 also includes a main memory 404. Control logic (software) and data are stored in the main memory 404 which may take the form of random access memory (RAM).

The system 400 also includes a graphics processor 406 and a display 408, i.e. a computer monitor. In one embodiment, the graphics processor 406 may include a plurality of shader modules, a rasterization module, etc. Each of the foregoing modules may even be situated on a single semiconductor platform to form a graphics processing unit (GPU). In another embodiment, the GPU may be included within a graphics portion of an SoC.

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 400 may also include a secondary storage 410. The secondary storage 410 includes, for example, a hard disk drive and/or a removable storage drive, representing a flash drive, a magnetic tape drive, a compact disk drive, etc. The removable storage drive reads from and/or writes to a removable storage unit in a well known manner.

Computer programs, or computer control logic algorithms, may be stored in the main memory 404 and/or the secondary storage 410. Such computer programs, when executed, enable the system 400 to perform various functions. Memory 404, storage 410 and/or any other storage are possible examples of computer-readable media.

In one embodiment, the architecture and/or functionality of the various previous figures may be implemented in the context of the host processor 401, graphics processor 406, an integrated circuit (not shown) that is capable of at least a portion of the capabilities of both the host processor 401 and the graphics processor 406, a chipset (i.e. a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 400 may take the form of a desktop computer, laptop computer, and/or any other type of logic. Still yet, the system 400 may take the form of various other devices m including, but not limited to a personal digital assistant (PDA) device, a mobile phone device, a television, etc.

Further, while not shown, the system 400 may be coupled to a network [e.g. a telecommunications network, local area network (LAN), wireless network, wide area network (WAN) such as the Internet, peer-to-peer network, cable network, etc.) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method, comprising:
identifying opacity data for a plurality of pixel values in a first format;
storing the opacity data for the plurality of pixel values in a second format; and
transmitting the opacity data for the plurality of pixel values, utilizing the second format.

2. The method of claim 1, wherein each pixel value of the plurality of pixel values has associated color data and opacity data.

3. The method of claim 2, wherein the color data and opacity data for each pixel value respectively indicate a color and opacity of that pixel when the pixel is displayed.

4. The method of claim 2, wherein the color data for each pixel value includes red, green, and blue (RGB) data.

5. The method of claim 1, wherein the opacity data for each pixel value includes an alpha value for the pixel.

6. The method of claim 1, wherein the first format of the plurality of pixel values includes a red green blue alpha (RGBA) format.

7. The method of claim 1, wherein the plurality of pixel values are stored as a graphic surface within a frame buffer.

8. The method of claim 1, wherein storing the opacity data for the plurality of pixel values in the second format includes gathering the opacity data from the plurality of pixel values.

9. The method of claim 1, wherein a pass shader of a graphics processing unit (GPU) extracts alpha values from each of the plurality of pixel values.

10. The method of claim 1, wherein storing the opacity data for the plurality of pixel values in the second format includes creating one or more opacity storage values in the second format.

11. The method of claim 10, wherein the opacity storage values include new pixel values that are created in the second format and that are used to exclusively save opacity values for the plurality of pixel values.

12. The method of claim 10, wherein storing the opacity data for the plurality of pixel values in the second format includes storing the extracted opacity data from the plurality of pixel values in the one or more opacity storage values.

13. The method of claim 10, wherein a single opacity storage value stores opacity data for a plurality of pixel values.

14. The method of claim 10, wherein both the plurality of pixel values and the opacity storage values are stored within a frame buffer.

15. The method of claim 10, wherein a data structure in memory is adjusted to allow the storage of both the opacity storage values and the plurality of pixel values within the data structure.

16. The method of claim 10, wherein both the pixel values in the first format and the opacity storage values in the second format are transmitted utilizing an interface connection, and the interface connection discards a portion of the pixel values in the first format during transmission.

17. The method of claim 16, wherein the recipient of the opacity data for the plurality of pixel values uses the opacity data for the plurality of pixel values to recreate the plurality of pixel values in the first format.

18. A computer program product embodied on a computer readable medium, comprising:
code for identifying opacity data for a plurality of pixel values in a first format;
code for storing the opacity data for the plurality of pixel values in a second format; and
code for transmitting the opacity data for the plurality of pixel values, utilizing the second format.

19. A system, comprising:
a processor for identifying opacity data for a plurality of pixel values in a first format, storing the opacity data for the plurality of pixel values in a second format, and transmitting the opacity data for the plurality of pixel values, utilizing the second format.

20. The system of claim 19, wherein the processor is coupled to memory via a bus.
